(19) United States
(12) Patent Application Publication
(10) Pub. No.: US 2025/0099955 A1
(43) Pub. Date: Mar. 27, 2025

(54) Expanded Matter Detection Using Algorithms

(71) Applicant: Keith Louis De Santo, St Petersburg, FL (US)

(72) Inventor: Keith Louis De Santo, St Petersburg, FL (US)

(21) Appl. No.: 18/646,731

(22) Filed: Apr. 25, 2024

Related U.S. Application Data
(60) Provisional application No. 63/540,053, filed on Sep. 23, 2023.

(51) Int. Cl. B01L 3/00

(52) U.S. Cl. CPC B01L 3/502715; B01L 2200/04; B01L 2200/14; B01L 2300/0654; B01L 2300/0681

(57) ABSTRACT

The new hand held device is called the hand held matter detection apparatus with a disposable cartridge. The new device is a smaller lightweight hand held universal multipurpose matter detection apparatus “UMMDA” with updated algorithms.

### CROSS-REFERENCE TO RELATED APPLICATIONS

This application claims priority to and the benefit of the following: U.S. Provisional Application No. 63/526,998, filed on Jul. 15, 2023, entitled ‘System and method for accurate detection and classification of matter and micro-organisms in indoor and outdoor environments using algorithms’; U.S. Provisional Application No. 63/540,053, filed on Sep. 23, 2023, entitled ‘Mobile automated medical image, laser and pin apparatus for diagnostics and treatment of malignant cells; U.S. Provisional Application No. 63/543,0537, filed on Oct. 11, 2023, entitled ‘Machine Learning Intelligence recognizance and disarming application for law enforcement and military operations; U.S. Provisional Application No. 63/566,521, filed on Mar. 16, 2024, entitled ‘Expanded Sample Matter Collection Method and Data Application’ U.S. Provisional Application No. 63/638,367, filed on Apr. 24, 2024, entitled ‘Device for bio-sensing microorganisms, cells, and contaminants in near real-time’ U.S. Provisional Application No. 63/638,362, filed on Apr. 24, 2024, entitled ‘Portable handheld device’ and U.S. Provisional Application No. 63/638,356, filed on Apr. 24, 2024, entitled ‘Method for detecting matter, pathogens and contaminates in specimens “, which are incorporated herein by reference in their entity. United States Patent Office application Ser. No. 18/141,374 and the World Intellectual Property Organization application PCT/US23/20501 will also be cross referenced in this application and will rely on some of the descriptions outlined in both applications.

### FIELD OF THE INVENTION

The field of invention is the detection of matter using algorithms. The present expanded technology are additions to a Universal Multipurpose Matter Detection Apparatus “UMMDA” described in USPTO application Ser. No. 18/141,374 and PCT application PCT/US23/20501. Both applications are based on detection of matter using machine learning algorithms. The overview of the prior UMMDA application can be utilized as a manual application where the user obtains samples of matter to test for pollen around their home. The UMMDA utilizes trained data to detect for all matter including allergens, molds, contaminates, bacteria and viruses. The matter is deposited into a receptacle connected to a liquid tube which pumps the matter (most times water is used) suspended in liquid through many image enlargement devices placed near the liquid tube that utilize computer software algorithms to detect any type of matter. As an extension of the prior applications, the new invention is an improvement of the UMMDA application filed by the inventor. The new field of invention is a manual hand held apparatus that is much smaller in size and utilizes a replaceable and disposable cartridge. The new hand held device apparatus is the “Hand Held apparatus with a disposable cartridge”. The liquid tube component of the prior UMMDA version has receptacle matter deposit upgrades and revisions and matter detection methods. They include a replaceable liquid tube cartridge, named “cartridge”, that can be replaced, cleaned, or reconditioned for further use. There are many new versions of the hand held apparatus with the disposable cartridge. The versions range from very expensive to very inexpensive depending on what additions were added. The following is the list of the new additions to the UMMDA. The liquid tube defined in the prior application by the inventor is a liquid tube consisting of microscope slides embedded in the liquid tube, pumps, receptacle for deposit of matter, track lighting, image enlargement devise, and basic algorithms. The algorithms were defined as operation and machine learning algorithms for detection of matter. The entire UMMDA apparatus can be explained in the prior applications but for purposes of this application the focus is a hand-held apparatus device that can be charged, ran on batteries, or connected to an electrical outlet that can be operated manually and in a remote area by user interface touchscreen. The focus will also be the algorithms have been updated and are more specific and the liquid tube has been reconfigured. The additions to the liquid tube, which is referred to as the disposable cartridge, incorporates the manufacture of the hand held apparatus with a disposable cartridge using a high-end 3D printer whereby the 3D printer can construct a liquid tube with a basic liquid tube design but can also be manufactured and constructed in a large manufacturing facility not using a 3D printer. The replaceable liquid tube cartridge with a receptacle, incorporates a new design with a smaller version of a tropical fish magnetic filter pump, tabs on the outside of the liquid tube cartridge to attach track lighting and string lighting replacing the use of microscope condensers, slots incorporated in the manufacturing of the liquid tube for magnets to slide in that will be the anchor for the liquid tube cartridge into the hand held apparatus with a disposable cartridge. The new design incorporates a new design of a small cylinder (spring loaded) at the end of the mainframe case of the hand held apparatus with a disposable cartridge whereby the liquid tube cartridge fits into the metal frame of the hand held apparatus with the disposable cartridge. Located at the top of the hand held apparatus with cartridge there can be swivel latch that will hold in the cartridge in place, or magnets affixed (slid in) to the outside of the liquid tube can be used to secure the cartridge in the hand held, can also utilize a valve to allow for the flows of liquid between the cartridge and receptacle, a breakable water tight seal between the liquid tube and the receptacle, the liquid tube cartridge can also maintain a seal made of plastic, paper, or rubber, where the paper is water soluble, whereby the receptable can be pressed into the liquid tube cartridge. On the low-end version of the hand held apparatus with a disposable cartridge, pumps can be replaced with methods of bubblers, different weight, and different size balls for mixing internally (homogenization) in the liquid tube and the low-end version of tipping and shaking to homogenize matter with the liquid in the liquid tube cartridge for detection. The UMMDA can now be used as a medical application for depositing blood, feces, urine, sputum, hair, fur, finger, and toenails, and on some occasions, fragments of teeth, bone, and tissue samples from a human and animal. The new technology is based on a new design of obtaining and inputting matter from human bodies into the hand held apparatus with a disposable cartridge for the accurate detection of matter in real-time using algorithms. Further, the present disclosure provides for an easier way of cleaning the hand held apparatus with a disposable cartridge after each use by offering a choice of a disposable cartridge that is designed to capture a plurality and mixtures of matter and fluids from human bodies or a new method of replacing the receptacle and the liquid tube cartridge with ease of use for the user. The hand held UMMDA apparatus with the disposable cartridge that's used in the detection application is a new method of detecting matter. The new application can also use robots and or drones (both by attached mechanical arm) to replace disposable cartridges in the new design of the hand held UMMDA apparatus with a disposable cartridge. The new design offers a larger application for farm animals and a smaller version of a hand held UMMDA apparatus with a disposable cartridge. The input of human matter, human bodily fluids and animal matter into a receptacle attached to the hand held apparatus with a disposable cartridge has been revised to make it more user friendly utilizing a touchscreen and easier to obtain human matter in the medical industry.

The subject matter discussed in the background section should not be assumed to be prior art merely as a result of mentioning the prior applications but addons and components to the original apparatus. Similarly, a problem mentioned in the background section or associated with the subject matter of the background section should not be assumed to have been previously recognized in the prior art. The subject matter in the background section merely represents different approaches, which in and of themselves may also be inventions.

### SUMMARY OF THE INVENTION

Currently, the prior UMMDA operates without an error check. The new invention has an upgraded version of an error health check algorithm. The system is monitored if clean and ready to detect matter sometimes referred to as a new “detection process”. The new user interface is a touchscreen with more options which can be used directly with the newly designed hand grip version which weighs approximately 4.98 lbs. The larger UMMDA version utilizes an industrial sized receptacle so that farm animals can be lowered into the receptacle for testing of surface matter. This new UMMDA application also has two new hardware components, a UMMDA liquid tube that is constructed to become one unit and a single unit reusable cartridge for non-transfer (for isolation of matter, hazardous matter, and stored matter for further testing) of contaminated matter from prior detection processes and applications. The new software components are algorithmic software programs that monitor if the system is clean, functioning correctly, if the UMMDA liquid tube is clogged, if the type of pump or gravity application is not functioning to enable flow of matter, and if any image enlargement device is not functioning. The purpose of the reusable cartridge is for use in the medical industry and veterinarian industry as opposed to environmental industry applications. Environmental applications can utilize continuous runs of detection processes and reuse cleaned cartridges whereby the medical industry and animal matter testing application for bodily fluids requires a clean start to each process and a “good to go” thumbs up from the apparatus that its ready with a clean slate. These new algorithms have replaced older algorithms, upgraded some algorithms while new algorithms have been added for more applications such as a revised user checklist. Also, a new Automated Biosensing Imaging System “ABIS” database technology has been added as a new software component to the UMMDA base technology. These algorithms have been updated and are shown in a flow chart in diagrams as to purpose, instruction and direction. The apparatus is a smaller version of the UMMDA that can be used and stored on a countertop in a medical testing setting for purpose of ease of use for inputting matter. Different sizes can be utilized whereby the small end apparatus (from 4.9 pounds) width of 12 inches and length of 16 inches can be moved easily where the larger models can range in weight to over 1,000 pounds with a width of over 20 feet and length of over 30 feet. One version of the hand held is under 6 inches in length and 4 inches in width, which is the top end smaller version in hardware. The larger models maintain more than four image enlargement devices, more than one pump and a longer liquid tube and more than one sensor. The receptacle can be used as a cleaning mechanism for farm animals while testing for surface matter.

In an embodiment of the new invention, the new invention can be administered by a smaller handheld UMMDA apparatus called a Hand Grip apparatus with a disposable cartridge.

In an embodiment of the new invention, since the hand held apparatus with a disposable cartridge is much smaller than the original UMMDA version in the prior application the hand held apparatus with a disposable cartridge can be used in a mobile setting or an untethered setting whereby the hand held UMMDA apparatus (hereafter the “hand held apparatus” with a disposable cartridge can be powered by a battery which can be used by a medical professional in a remote area.

In an embodiment of the invention, a medical professional can operate the hand held apparatus with a disposable cartridge manually.

In an aspect of the invention, a medical professional can perform a variety of tests from a hand held apparatus with a disposable cartridge. The hand held apparatus with a disposable cartridge can test for bodily matter from a human and animal patient.

The medical hand held apparatus with a disposable cartridge utilizes a replaceable, disposable, and cleanable cartridge that can be inserted in a spring-loaded version and held in by a latch, see FIGS. 16 and 17, whereby the cartridge is designed to be removed and replaced from hand held apparatus with a disposable cartridge.

The medical professional with continuous power supplied to the hand held apparatus with a disposable cartridge, can operate the Hand Grip apparatus with a disposable cartridge in a continuous manner after replacing a disposable cartridge which is designed to be replaced after each test.

In an embodiment of the new invention, the hand held apparatus with a disposable cartridge can maintain a battery charge and supply power for up to 22 medical tests from a patient. See FIG. 9.

In an aspect of the invention, the hand held apparatus with a disposable cartridge can stay charged for 16 hours without being used.

In an embodiment of the new invention, the liquid tube unit is defined as the replaceable disposable cartridge that can be constructed as a single unit. The replaceable cartridge is the liquid tube itself. See FIG. 10, 12, 18, 23. The replaceable liquid tube disposable cartridge can be manufactured with the receptacle or without it. The disposable cartridge receptacle can be pressed on the liquid tube at a later date if manufactured separately. Further, the replaceable liquid tube disposable cartridge can be manufactured with a receptacle attached or without it. The hand held apparatus with a disposable cartridge component consists of and is defined as the liquid tube with two microscope slides embedded and constructed within the unit whereby the liquid tube is connected to a receptacle for the deposit of matter, a small platform inside the tube where a liquid pump can be affixed, 4 tabs to attach string and track lighting (2 on each side of the liquid tube), 4 other tabs to slide 4 magnets onto the side of the liquid tube, and 2 ridges of uneven thickness each to slide into the hand grip handheld apparatus metal frame case. The 2 microscope slides are the full length of the liquid tube to allow for 4 image enlargement devices to be placed over the top microscope slide whereby the top microscope slide is larger than the bottom microscope slide which will allow for matter mixed with liquid to go through the two microscope slides in the liquid tube whereby the matter and the liquid goes over the surface of the bottom microscope slide and between the 2 microscope slides. See FIG. 27. A bubbler can also be incorporated in the liquid tube construction, as in FIG. 27, whereby the bubbler inside the liquid tube can be attached to a hose outside the liquid tube that supplies air from a pump located inside the metal frame case of the hand held apparatus.

In an embodiment of the invention, magnets on the hand held apparatus with a disposable cartridge slid into a slot on the liquid tube or affixed (“glued”) hold the hand held apparatus with a disposable cartridge in place in the handheld apparatus metal frame case which also has magnets to hold the liquid tube in place. See FIG. 15.

In an embodiment of the invention, ridges on the construction of the hand held apparatus with a disposable cartridge will be used to hold the liquid tube in place in a version of the liquid tube replaceable cartridge. See FIGS. 17 and 27.

In an embodiment of the new invention, the hand held apparatus with a disposable cartridge has 6 versions of the disposable cartridge. The first version is an internal pump which can be constructed inside the liquid tube or placed inside the liquid tube after construction. The pump will circulate the matter and the liquid in the replaceable liquid tube cartridge. The second version of the disposable cartridge can be manufactured to include a bubbler like that in a tropical fish tank in a residence. The liquid tube unit can be manufactured to include a bubbler. The hand held apparatus with a disposable cartridge can be constructed to incorporate different types of internal pumps. One such pump can be operated wirelessly and wired. Another such pump can be operated by magnets externally by magnets as in a tropical fish tank pump, using magnetic pumps. The pump can be operated from outside the liquid tube unit by magnetic application such as a tropical fish filter. A magnetic liquid pump is powered through the use of magnetism rather than electricity from an outside source. The magnetic liquid pump requires no seals or lubricants for operation. The magnetic pump can circulate many types of fluids. Because of this design, the chance of a liquid leak is limited. The basics of how the magnetic pump works is where a rotating impeller located in an enclosed housing in the liquid tube is powered by rotating magnetic fields produced by individual magnets outside the liquid tube. The rotation of the impeller produces a force that drives the liquid and matter throughout the liquid tube. The magnetic pump drive, the impeller, and the motor all have magnets attached to them. The magnets are attached to the pump drive assembly, which is called the drive magnet, whereby this drive magnet is responsible for driving the inner motor which is attached on a second shaft operated by a motor. When the motor is turned on it spins its magnet whereby the magnetic force by the motor's magnet causes the magnet in the pump in the liquid tube to spin and rotate the impeller causing force to move the liquid and matter along the liquid tube. The magnetic pump drive is a centrifugal pump meaning the liquid pumped through the system exists at a different point than where it's sucked into the pump in the liquid tube. When the matter and liquid enter the pump, it is thrown off the impeller and into a discharge chamber of the pump which flows into the liquid tube. The rotation of the impeller causes the liquid to increase in energy, increasing the amount of pressure in which the liquid and matter discharges from the pump. This increase in pressure is what keeps the fluid moving throughout the liquid tube. The low-end version of the hand held apparatus with a disposable cartridge can use the tipping or shaking method in lieu of pumps, as described below, to have the matter and liquid homogenized. The metal frame is encased in plastic whereby the front of the hand held apparatus with a disposable cartridge has a user interface touchscreen while the back of the hand held apparatus with a disposable cartridge can be removed. The internal liquid tube pump can be inserted before construction of the liquid tube or after construction. The bubbler can also be inserted before or after construction of the liquid tube unit. For purposes of this application, the hand held apparatus with a replacable cartridge is defined as the liquid tube which includes a wireless pump, 2 microscope slides, 4 image enlargement devices, or both a magnetic pump, tabs for track lighting, magnets, magnet tabs where the magnets are affixed to the liquid tube, and a receptacle that can either be manufactured onto the liquid tube cartridge or added separately and pressed on later for a water tight seal with a rubber gasket (o ring) between the liquid tube and the receptacle.

In an aspect of the invention, 4 enlargement image devices with separate algorithms, will monitor if all internal areas of the liquid tube are clean of foreign matter before a new start.

In an aspect of the invention, various chemicals can be used to clean all internal areas of the liquid tube. Whereas one of the cleaning materials can be a biosurfactant, specifically a rhamnolipid.

In an embodiment of the invention, the high-end version of the hand held apparatus with a disposable cartridge will also utilize the internal pump of the liquid tube to clean the liquid tube by attaching a hose to the outside of the hand held apparatus with a disposable cartridge where the hose will pump clean sterile fluids to clean the hand held apparatus with a disposable cartridge.

In an aspect of the new invention, the new unit can be made by a 3D printer whereby 2 microscope slides, the liquid tube, a receptacle, 2 tabs for tracks and string lighting can be made with 4 magnets embedded. See FIG. 10.

In an aspect of the new invention, the 4 magnets of the disposable cartridge will line up with 4 magnets inside of the metal frame of the hand held apparatus.

In an embodiment of the new invention, a receptacle can be made separately from the liquid tube unit whereby the receptacle can be pressed on into the liquid tube unit to become one unit. See FIG. 23.

In an embodiment of the new invention, as long as a 3D printer is available that is a high-end version to construct a replaceable cartridge, the cartridge unit will maintain 2 elongated (the bottom microscope slide is shorter than the top microscope slide.), an endless supply of hand held disposable cartridges.

If the hand held apparatus with a disposable cartridge has the version of a disposable cartridge application, the hand held cartridge can be cleaned and inserted for another test.

In an embodiment of the invention, on some version the receptacle can be removed to be cleaned by inserting a nozzle to pump a cleaning solution with high pressure. See FIG. 23.

In an embodiment of the invention, the hand held apparatus replaceable cartridge can be cleaned, replaced, or reconditioned.

In an embodiment of the invention, the hand held apparatus disposable cartridge can be constructed with liquids inside the liquid tube unit.

In an aspect of the invention, the hand held apparatus disposable cartridge can be filled by a medical professional by removing the top rubber cap of the cartridge, replacing the fluid, and replacing the O-ring seal. See FIG. 23.

In an embodiment of the invention, the hand held apparatus disposable cartridge can be removed and replaced with ease.

In an aspect of the invention, the hand held disposable cartridge presses into the hand held metal frame in 3 manners whereby the first manner the liquid tube fits inside a cylinder inside the Hand Grip apparatus. See FIGS. 16 and 17.

In an aspect of the invention, the disposable cartridge can be constructed with 4 magnets embedded in the liquid tube unit to match up with 4 magnets inside the hand held metal frame.

In an aspect of the invention, the hand held replaceable cartridge can slide into the handheld metal frame case whereby ridges constructed on the tube are different thicknesses for easy insertion into the hand held apparatus.

In an embodiment of the invention, the testing data from the hand held apparatus with a replacable cartridge can be performed to test many different human bodily fluids.

In an embodiment of the invention, the hand held apparatus with a replacable cartridge can test blood for abnormalities and blood count, skin cells for healthy skin cells and abnormalities, tissue for healthy cells and abnormalities, hair for traces of foreign matter, finger and toe nails for abnormalities, sputum for healthy cells and abnormalities, urine for abnormalities, feces and stool for abnormalities and in some instances organ tissue and bone fragments abnormalities.

In an aspect of the invention, if bone and organ matter is deposited into the receptacle, the hand held can be used in this setting to test for abnormalities in the matter.

In an embodiment of the invention, the hand held disposable cartridge can be filled with distilled water, another sterile liquid, or a combination of both whereby the cartridge is sealed by a rubber valve and O-ring, or a seal made of plastic or rubber as shown in FIG. 23.

In another aspect of the invention, the hand held apparatus replaceable cartridge can be manufactured with a sterile liquid, whereby the shelf life of the hand grip disposable cartridge can be up to 4 months with some liquids prolonging the shelf life to one year.

In an embodiment of the invention, the sterile testing of bodily fluids is important. Therefore, a version of the hand held apparatus with a disposable cartridge utilizes a closed receptacle whereby the pumps in the liquid tube draw the matter and liquid from the receptacle into the liquid tube for testing. This is after the bodily fluids mixed with liquids are deposited through the top of the receptable. This is after the matter sample has been taken from the patient.

In an embodiment of the invention, the Hand Grip disposable cartridge can be washed with a sterile process by removing the receptacle component from the liquid tube component for direct access to the internal area of the liquid tube component of the Hand Grip disposable cartridge.

In an embodiment of the invention, the liquid tube unit in the hand held replaceable cartridge can be filled with liquid by a medical profession at a medical facility manually or by UMMDA robot.

In an embodiment of the invention, for the shake and tip version, a liquid fill measurement line is at the top of the liquid tube unit inside the hand held replaceable cartridge whereby room must be left for air to remain in the hand grip disposable cartridge after filling with liquid. This is apparent to leave some room for an air bubble to remain in the cartridge after filling to expedite mixing and flow of matter suspended in the liquid.

In an aspect of the invention, the hand grip replaceable cartridge liquid tube unit will offer the mixing of bodily fluids to become homogenized inside the receptacle of the hand held replaceable cartridge.

In an embodiment of the invention, the receptable attached to the cartridge of the hand held apparatus is used to obtain bodily fluids from a human or animal patient.

In an embodiment of the invention, the bodily fluids of a human or animal are deposited into the hand held apparatus replaceable cartridge receptacle by placing, dropping, or the pin prick method described in FIGS. 19, 20, and 21.

In an embodiment of the invention, bodily fluids such as sputum, stool, blood, and urine can be deposited into the hand held apparatus receptacle for testing.

In an embodiment of the invention, a swab can be used to collect saliva from a patient's mouth and rub the swab against the inside wall of the receptacle. The swab can be rubbed submerged in the liquid tube or above the water line. More liquids can be used to water down the inside of the receptacle to accelerate the transfer of saliva in the liquid into the receptacle.

In an aspect of the invention, a patient can spit sputum into the receptacle for testing purposes or for testing of their sputum.

In one embodiment of the invention, the receptacle to the hand held apparatus is lying flat on a countertop, whereby liquid is poured into the receptacle transferring matter into the cartridge.

In an embodiment of the invention, the valve to the hand held apparatus replacable cartridge is opened whereby the liquid mixed with matter inside the receptacle can be transported into the liquid tube unit for matter detection. See FIGS. 10, 18, and 26.

In an embodiment of the invention, the hand held apparatus can be tipped 16 degrees back and forth for matter to be transferred into the hand held replaceable cartridge for detection by the 4 image enlargement devices that are supplied power by the battery pack or electricity to the power unit as described in FIG. 13.

In an aspect of the invention, the low-end version without any pumps or bubblers in the liquid tube utilizes a tip and shake method to homogenize the liquid in the liquid tube cartridge with the matter. The liquid tube in the hand grip apparatus replacable cartridge will provide the mixing of bodily fluids to be become homogenized in the liquid tube enabling mixing of the bodily fluids to flow over the top surface of the bottom microscope slide. The liquid tube cylinder with some air in the liquid tube will offer the mixing of bodily fluids to become homogenized throughout the liquid tube whereby the air pocket enables the space to mix the liquid and matter.

In an aspect of the invention, the air pocket in the liquid tube in the hand held apparatus replaceable cartridge will allow the bodily fluids to become homogenized to travel between both microscope slides in the liquid tube unit to provide the image enlargement devices to gather images and data on the bodily fluids.

The hand held apparatus operates in the same manner as prior UMMDA versions in prior applications whereby algorithms are used to detect matter in their normal and abnormal structure using image enlargement devices that are connected motherboards in computers whereby the UMMDA algorithms detect the matter in real time.

The algorithms have been updated where there is now a control unit algorithm that controls all aspects of the application.

In one aspect of the invention, a pin is located in the reservoir of the hand held apparatus receptacle to induce bleeding from a patient.

In an aspect of the invention, a patient is instructed to press their finger against the pin in the hand held apparatus receptacle to induce bleeding.

In an aspect of the invention, the pin prick method in the last section is used to flow blood samples from the hand held apparatus receptacle into the hand held replacable cartridge for matter detection.

In an aspect of the invention, the blood in the receptacle from the patient can be transferred into the hand held disposable cartridge in 5 methods.

This first method is by tipping the hand held apparatus.

The second method is by closing the valve to the liquid tube unit in the replaceable cartridge and shaking the unit.

The third method of transferring bodily fluids from the hand held apparatus receptable is by using plastic balls weighted in different weights that flow from the receptacle into the hand grip cartridge whereby the balls are deposited into the reservoir before any liquid is added to the reservoir whereby the plastic balls enter after the pin prick method.

The fourth method is where a pump pulls human bodily fluid matter from the receptable into the liquid tube replaceable cartridge.

The fifth method of bodily fluid transfer from a patient into the hand held apparatus disposable cartridge receptacle also utilizes tiny bits of fabric or water-soluble fabric that are placed into the disposable cartridge by a medical professional using forceps and tweezers to deposit the water-soluble material into the cartridge.

In an embodiment of the invention, a medical professional can deposit a water-soluble fabric or paper or directly deposit the bodily fluid with a dropper or a hypodermic needle into the replaceable cartridge and simply close the top of the liquid tube with a rubber stopper for a one-time use. Place the cartridge back into the hand held apparatus with a disposable cartridge for testing of human bodily fluids.

The medical professional can also deposit the water-soluble fabric directly into the receptacle linked to the replaceable cartridge.

In one aspect of the invention, upon the pin prick of the blood in the finger water-soluble fabric is used to wipe blood from the finger and place directly into the cartridge for matter testing.

In one aspect of the invention, upon the pin pick of the blood in the finger after removing the finger, tip the hand grip to the right and to the left 4 times and the bodily fluids will travel under the image enlargement devices for imaging.

In an aspect of the invention, if the four image enlargement devices do not detect any matter form the bodily fluids, open, the manual application directs the closing of the valve and to shake the hand held apparatus lightly 4 times to homogenize the matter in the liquid. If a liquid pump is used in the application, the pump can remain on or be controlled by an algorithm to run at certain time intervals.

In an embodiment of the invention, the UMMDA liquid tube application can be manufactured with a liquid pump positioned anywhere in the liquid tube cartridge or in some versions, the liquid pump can be free floating.

In an embodiment of the invention, a high end hand held disposable cartridge can be manufactured with a small pump at the top or bottom of the liquid tube unit between the receptacle and the liquid tube unit as in FIGS. 12 and 25 whereby the pump is activated wirelessly to pull the liquid and the matter from the receptacle into liquid tube unit whereby the pump activated wirelessly by the algorithm continuously pumps liquid and matter over the bottom microscope slide as well as between the 2 microscope slides, as in the prior UMMDA application using a control unit, in the liquid tube cartridge unit, as described in FIGS. 12 and 27.

In an aspect of the invention, the liquid tube unit of the cartridge maintains a miniature pump that can have 3 methods of operation. 1) continuous pumping of bodily fluids suspended in the liquid over the bottom microscope slides and between the two microscope slides until one of the four image enlargement devices detects the matter that it has been programmed to detect using different algorithms.

In an aspect, the miniature pump manufactured within the hand held apparatus disposable cartridge can operate wirelessly whereby no wires are needed and the pump is located inside the liquid tube. It can also be operated by a miniature pump inside the liquid tube that is connected externally to a power source as in FIGS. 12, 25, and 27.

In an embodiment of the invention a pump with magnets can be operated from outside the liquid tube unit to propel bodily fluids and liquids over the top surface of the bottom of the microscope slide and between the two microscope slides in the liquid tube cartridge.

In an aspect of the invention, the pump is located inside the liquid tube cartridge and is operated and controlled outside the liquid tube unit.

The pump is submerged in the liquid and can be operated remotely.

In an embodiment of the invention, a wireless bubbler can be constructed in the liquid

tube replaceable cartridge whereby the bubbler can be wirelessly operated whereby the bubbler is submerged in the liquid in the liquid tube cartridge as opposed to using a pump.

In an aspect to the invention, you can use both a bubbler and a pump in the liquid tube cartridge to circulate matter and liquid.

In an embodiment of the invention, the disposable cartridge can be cleaned while being maintained inside the hand held apparatus whereby a sterile fluid can be pumped into the liquid tube unit to clean out the matter. The cartridge can be refilled with liquid and a rubber stopper can be affixed to the top of the liquid tube.

In an embodiment of the invention, a pump can be used to circulate sterile liquid to clean the cartridge that is heated whereby the liquid tube cartridge can withstand high heat for cleaning purposes.

In an aspect of the invention, in regard to maintenance, the back plate to the hand held is removable whereby the 4 image enlargement device lens can be cleaned by pressured air or a very small cotton swab or UMMDA robot.

In an embodiment of the invention, maintenance can be done on the hand held apparatus whereby the back plate of the hand held apparatus with a disposable cartridge can be removed.

In an aspect of the invention, after removing the back plate from the hand held apparatus, the four image enlargement device lenses, or any other component that requires maintenance, can be cleaned by pressured air or a tiny cotton swab with a cleaning solution utilizing a UMMDA robot to clean the hand held apparatus with a replacable cartridge.

In an aspect of the invention, after the back plate of the hand held apparatus has been removed, all components of the hand held apparatus can be inspected, updated, removed, replaced, or fixed if a malfunction has taken place. The back plate snaps on and off the metal frame of the hand held apparatus with a replaceable cartridge.

In an embodiment of the invention, the following addon or upgrades can be utilized or not in many different versions of the hand held apparatus with a replacable cartridge: One of the new components to the application has 16 new addons whereby the next 16 sections list each addon or upgrades component. The addons and upgrades are 1) a UMMDA device that has a touch screen interface, 2) an opening in the frame that holds a UMMDA replaceable cartridge 3) a replaceable cartridge that utilizes low grade magnets to hold the liquid tube in place in its new hand held metal frame housing. 4) A receptacle that is covered for sterile purposes before and after use. The receptacle is covered with a water-soluble paper or fabric or a plastic wrap that can be broken by pressing a finger against it for depositing matter that is also affixed to the replaceable cartridge for easy matter entry. 5) where both the receptacle and the cartridge can either be cleaned or replaced. 6) The receptacle is directly attached to the cartridge for the blood pin prick method (described later), sputum, phlegm (matter from mouth), urine, stool, skin cells, hair, and organ matter can be deposited directly into the cartridge for testing. 7) a smaller UMMDA that be used and stored on a countertop in a medical testing setting and facility for purpose of ease of use for inputting matter. 8) algorithms that monitor and manage errors. 9) the smaller apparatus maintains a connection for charging the battery if the apparatus is run by battery. 10) the smaller apparatus maintains a USB port connection, or other data transfer cables for upload of system updates and download of data to a laptop, server, or desktop computer. 11) an SD card slot for easy upgrades and or downloads of data if apparatus is not connected to a computer. 12) a battery replacement slot for rechargeable batteries when a hand grip unit comes with rechargeable batteries. 13) a port to charge the battery or run on electricity. 14) a wireless component with an on and off toggle switch on the user interface face touch screen 15) a solid state storage device. For purposes of this application, a cartridge is a case or container that holds a substance, device, or material that can be easily changed. 16) a medical professional can deposit matter directly into the liquid tube, add liquid, and replace the rubber stoppers for testing in the new apparatus.

In an embodiment of the invention, a medical professional can wipe a patient with a water-soluble fabric or paper and obtain sputum, blood, urine, or a stool sample and placed into the liquid tube cartridge, liquid is added by the medical professional, and a rubber stopper is secured to the top of the liquid tube.

In an embodiment of the invention, a medical professional can use a pin-prick method within the receptable or outside of the receptacle to induce bleeding and enter that blood sample manually into the liquid tube cartridge anyway they see fit for testing.

In an embodiment of the invention, a new receptacle design that acts as a facilitator to obtaining blood samples from humans and animals. The receptacle has two applications, one with a pin affixed to the side of the receptacle above the liquid line of the receptible and one pin on the other side (opposite) that pin where the pin is submerged in the liquid of the receptacle. The first pin can be used to prick the skin of an animal or human to drip the blood into the receptacle. The second pin is also to prick the skin of an animal or human whereby the blood flows or is deposited directly into the liquid solution. This application is for a blood test.

In an aspect of the invention, a veterinarian can simply deposit any animal fluids, skin, fur, tissue, hair, or any matter from an animal into the liquid tube replaceable cartridge, add liquid, seal with a rubber stopper, and test in the new UMMDA device.

A 17^{th} new addon to the UMMDA, is a new biosensor device that is either placed in the receptacle connected to the liquid tube, or inside the liquid tube of the UMMDA apparatus. The biosensor measures biological or chemical reactions by generating signals proportional to the concentration of an analyte in the reaction in the tube or receptacle. The biosensor can monitor or detect the composition of biological and chemical reactions within the liquid tube or receptacle including florescence. The reaction of the biological or chemical reaction generates signals limitations of these methods are monitored by UMMDA algorithms.

A further addon (18^{th} addon), a receptacle designed with no liquid present in the receptacle to enable a light based or other electromagnetic, radio-active or sound frequency-based sensor to evaluate matter.

A further addon (19^{th} addon) is the ABIS (Automated Biosensing Imaging System) or cloud computing comprised of a computing and memory application, enabling the sensing, evaluation and reporting of data obtained from matter contained in the UMMDA.

A further addon (20^{th} addon) is an algorithmic software application providing metrics and analytics of the results obtained from the new UMMDA applications.

A further addon (21^{st} addon) to detect life in the universe or astro-biological matter using the UMMDA.

A further addon (22ond addon) where expanded machine learning algorithms allow for backend propagation of database analysis.

This specification recognizes that there is a need for an apparatus and method that do not use chemicals, require no maintenance, are fully managed by an artificial intelligence and machine learning platform, and provide solutions that leave no residual effect on the environment.

The present disclosure addresses these issues by also providing a replaceable transparent liquid tube designed for real-time pathogens or contaminant detection in a secure and dependable way. This technology can aid in the detection of pathogens or contaminants, preventing the spread of diseases and reducing the associated costs and risks. Real time data is paramount in any setting whether it be an airport or a hospital.

The disadvantages and limitations of traditional approaches will become apparent to the person skilled in the art through a comparison of the described method with some aspects of the present disclosure, as put forward in the remainder of the present application and with reference to the drawings.

An aspect of the present disclosure relates to methods of matter data capture and the methods of compilation, organizing, analyzing the data, and using machine learning to learn from the data. After these steps, specific machine learning algorithms are used to predict future events.

An aspect of the present disclosure relates to methods of data capture of matter as described in the Universal Multipurpose Matter Detection Apparatus “UMMDA” in the prior applications. The UMMDA is an apparatus that obtains matter for detection utilizing drones, robots (automated application) and by hand (manual application) that also utilizes algorithms (operation of apparatus) and machine learning algorithms (learning from data compiled). For purposes of this application, matter is defined as anything that has weight and takes up space.

An aspect of this application is the method of obtaining matter from humans and animals and the organization, analyzation and the machine learning results from that data. The application utilizes specific algorithms for the operation of all components of the application (operation algorithms) as well as machine learning algorithms (learning algorithms) as defined herein.

An aspect of the application is the constant machine learning. The entire application and all the types of data being used whether it be error data in from an application or malfunction of a hardware or software component is constantly being learned from by machine learning algorithms.

Another aspect of the present disclosure is to provide a system for detecting pathogens or contaminants in a liquid sample using the replaceable liquid tube cartridge as defined herein.

The present disclosure also introduces a new software application whereby data from databases that are basic but also specialized. The Automated Biosensing Imaging System or ABIS is hereby introduced. For purposes of this application, ABIS data, ABIS data application or ABIS data pool will be defined as any data that was captured or obtain by the apparatus or any of its components, data pools compiled and analyzed or any data that is stored by use of any component of the apparatus and its applications. The ABIS data is also any machined learning application that produces a final result, any identifying algorithm for detection, any operational algorithm or computer software application, any error data, any matter data whether known or unknown data, any exact GPS data (longitude and latitude data) where data was detected, or any unknown phenomenon that the apparatus detects or comes into contact with whereby an example would be how a virus or bacteria survived in a setting that offers no chance of survival. Any data that is unknown will be assigned a name by the ABIS.

In some embodiments, the UMMDA may not utilize the ABIS. For purposes of this application, any size of the UMMDA will be referred to as the UMMDA, the apparatus, or the UMMDAmanver whether or not it is a handheld device, a stationary device or a large industrial UMMDA which may be bigger than a tractor trailer.

In some embodiments, the ABIS is designed to categorize what data goes where and in what folder in the ABIS database. The ABIS is designed to utilize data to and from the UMMDA, as well as the handheld device, servers, computers, laptops, cellphones, and the cloud. ABIS can be managed from an SD card, an external hard disk storage device, a server farm, and all ABIS cloud interactions. For purposes of this application, ABIS cloud data pool will be defined as computer data storage in which data from the UMMDA is stored remotely and is accessible to users over a network which would be the internet.

An aspect of the present disclosure relates to the methods and steps of collecting matter from both living and dead beings (including both humans and animals). The ABIS data can be utilized and also stored on a smartphone, a tablet, a laptop, servers or desktop computer or an array of computing software devices.

The ABIS for purposes of this application, will be defined as computer data storage in which data from the UMMDA is stored remotely and is accessible to users over a network which would be the internet.

In an aspect, the further method includes a step of collecting matter from both living and dead beings which includes both humans and animals. The method includes a step of obtaining matter from a data pool. For purposes of data pool, the data pool will be defined as all types of matter which includes any fluids, stool, blood, organ tissue, hair, skin cells and bone fragments that are obtained from humans and animals. Included in this data pool of matter also includes foreign matter that can also be obtained from humans and animals. This type of matter can be found in mouths by intake of air, food, and liquids and foreign matter that was introduced into the mouth such as contaminates and pollutants with an example of smoke particles, fertilizers, and fecal matter. Contaminates and pollutants and foreign matter, unhealthy cells, abnormal cells can also be found in data pool matter. Foreign matter can also be food particles, fragments of teeth, and liquid residue such as tobacco. The data pool of matter also exists from space where some matter is unknown, unnamed, and is outside of earth. Matter is defined as anything that has weight and takes up space.

In some embodiments, when the UMMDA application is used in the medical industry, certain testing of certain matter is germane to that industry, but the data used in UMMDA machine learning applications may also come from other industries and applications such as the environmental industry. In the medical industry data comes from humans, test tubes or from physical matter found inside of the medical facility. In the environmental industry, data may come from bodies of water. Both data pools may be used in predictive data whereby forecasted events may be in residences. Stationary or mobile drones and or robots can assist in the automated application of obtaining data from patients, and or the surroundings and compare both sets of data using “point of contact algorithms”. An example would be if a patient of a hospital contracts a sickness and the doctors would desire to know if the sickness and or strain of bacteria, virus or fungus that caused that specific sickness was also found on the floors, walls, or anything else inside the hospital. If the strain of bacteria that caused the sickness in the patient, is also the same strain of bacteria that was also found 3 doors down on a floor by a UMMDA robot, the point of contact algorithms will note the relationship and possibly learn from the data pool. This specific machine learned data may save lives.

In an aspect, the apparatus application utilizes the covered pin prick receptacle in a medical setting to obtain a blood sample from a patient whether a human or an animal. The UMMDA pin prick application is used in the following manner. The receptacle that is attached to the UMMDA for entrance of matter in the liquid tube component can have this unique characteristic for medical applications.

In an aspect of the invention, the receptacle has a whirlpool mechanism that turns the liquid clockwise or counterclockwise whereby causing the blood from the puncture of the skin to become flowing and into the liquid tube. The flow can be induced by pumps are simple gravity. This same mechanism can also be used to break apart matter so that the matter may touch the surface of the microscope slides located in the liquid tube. An example of this may be the space between the microscope slides may be set and the matter cannot fit between the microscope slides in the liquid tube. The matter must be broken apart by the whirlpool device which can have protruded teeth like those of a food blending machine. On some higher end versions of the UMMDA, the space between the microscope slides in the liquid tube can be adjusted. The liquid can either be transparent on non-transparent and can be any singular or combination of gases, liquids or in some cases solids such as ice and a semi solid based material. Different types of medium in the liquid tube may be used to lighten or darken the matter for image enlargement purposes.

In an aspect of the invention, the top of the receptacle can have a thin layer of plastic, paper or rubber-based material that covers the entire top of the receptacle to keep it sterile before and after use. In FIGS. 12, 14, and 26 the receptacle may also have a dome swivel cover. The human body part can be cleaned with alcohol before being entered into the a larger receptacle. Upon pressure from a finger, a toe, or an arm (requires a larger receptacle), the material is broken, and the body part enters the receptacle space. The receptacle has a liquid level line whereby one side of the receptacle maintains a sharp pin above the liquid line (can be made of any material including a hollow needle-based pin or a hypodermic needle) to pierce the skin enough to visually see bleeding. The blood is then dripped into the receptacle. The other side of the receptacle can also have a pin affixed to the inside of the receptacle below the liquid line whereby the pin prick will produce a blood sample into the UMMDA without the drip. Utilizing the UMMDA for blood testing is in real time, results immediate and the costs are lower with less mistake of tainting.

In an embodiment of the invention, a method can be used to drip matter from a hypodermic needle into the receptacle above the water line or the matter from the syringe can be injected below the water line into the receptable.

In embodiments of the disclosure, the algorithms used with the UMMDA applications are developed for specific use with the application, the use of licensed and free to use third party algorithms are also used with the UMMDA application or a combination of both.

In embodiments of the application, there are numerous specific types of algorithms which include but are not limited to control algorithms, instruction algorithms, error algorithms, machine learning algorithms, predictive algorithms, automated algorithms whereby the entire operation (both software and hardware applications) of the applications are managed by control algorithms. An updated touch screen whereby users can be more involved in the processes of detection of matter. An example would be where a certain version of the UMMDA is set to run for a minimum of 1 hour as a default. The user can override that default by revising the time. New UMMDA algorithms seek answers from questions to the user whereby offering a level of comfort and comprehensive instruction (see FIGS. 1,2,3,4 and 9) This back and forth from user to UMMDA algorithms is beneficial to both user and UMMDA algorithms whereby both user and UMMDA algorithms learn from each other. While learning from these choices, the new algorithms (machine learning) can forego all automation and have the user manage all UMMDA operations by interacting with a touch screen user interface on a UMMDA laptop. Or the UMMDA can take over some or all automation.

Accordingly, one advantage of the present invention is that it does not use chemicals, requires no maintenance, and is fully managed or automated by control and operation algorithms that mange the entire system and machine learning algorithms that learn from every facet of every application, which includes failures, application successes and detection of unknown data or processes, and will provide real time data and solutions that leave no residual effect on the environment. The user does not have to be in contact with any component of the UMMDA other than the disposable cartridge (if equipped with such) and the laptop screen.

The flow charts to some of the main algorithms are listed in the figure sections at the end of this application.

The following detailed description is made with reference to the accompanying figures.

It is further important to note that the figures included in the present disclosure are not to scale. While the figures are intended to illustrate the key features and functionality of the invention, they are not intended to represent the size or proportion of any various components accurately. Instead, the figures are intended to provide a clear and concise depiction of the invention that will aid in understanding its operation and functionality. It should be understood that the relative sizes and dimensions of any components may differ from what is shown in the figures and that the figures should not be relied upon for precise measurements or scaling. The description provided herein should be consulted for further details regarding the size and dimensions of the invention.

The UMMDA is also referred to as both the new version and old version whereby components are interchangeable on some versions of the “Hand Held Apparatus”. An older version of the UMMDA apparatus is stilled used as a closed system where liquid and matter are continuously circled through the apparatus where only new matter is entered via the reservoir. With this closed UMMDA option, contaminates and microbes detected are specific to an area. The new application utilizes ABIS and some of the following components and versions.

The hand held version utilizes smaller components than the prior version. Image enlargement devices, pumps, receptacles, and microslides are decreased in size during construction. The smaller UMMDA components are constructed with simulation software which simulates the structure, operation, and manufacture of the components sending the specifications to a 3D printer to make some or all of the components. Some components are nanosized and purchased from third parties, while others are made from 3D printers.

An aspect of the invention is such that a disposable cartridge can be secured and stored with a hazardous matter material for later additional testing. Some versions of the UMMDA will offer a replaceable cartridge that is not held in place with magnets. The magnets may affect the outcome of results whereby a more robust cartridge (thicker plastic used in the 3d printer and a thicker rubber seal in lieu of paper is used to avoid seepage) is used and secured by a simple tab that holds the cartridge in place in the UMMDA apparatus.

The UMMDA application for the medical industry is also specific whereby the matter is very specific in whom the data is obtained from and what data is obtained. Blood, sputum, bodily fluids, stool, urine, skin tissue, hair, finger, and toenails, and in some occasions bone marrow and organ tissue tells a specific story and what event or events may occur in the future for a single person or a group of people. An example of the ABIS data pool application would be age, gender and environmental surroundings with a data pool consisting of past present and future diet of an individual (types of foods and drinks) may become an outlier of things to come as a skin disease. In the future that particular skin disease may be linked to a type of diet and combinations of specific foods, drinks and environment may be the cause. The UMMDA machine learning algorithms and predictive algorithms also rely on how the data is interpreted by the ABIS. This ABIS new application does not place the data in one folder or application but throughout many different scenarios in the ABIS including what other influences were forced upon the final data point. An example of this is if a test of hair from an individual detecting the presence of a poisonous chemical residue, the algorithm would seek out did their diet have an impact on the results. In some outlier cases, ingestion of fumes/gases/vapors by accident leaves some traces that can be detected by the UMMDA from hair and blood samples. Also noted is the unknown ingestion of chemical contaminates from food causing sickness. The UMMDA can also test for foreign matter in foods.

In an embodiment of the invention, the UMMMDA robots will obtain matter testing samples from humans and animals.

In an embodiment of the invention, UMMDA robots and or drones will replace the replaceable liquid tube cartridge in the Hand Grip apparatus with a disposable cartridge.

In an embodiment of the invention, both drones and robots will automate and assist in all aspects of gathering matter from patients, managing the ABIS databases, and will perform maintenance on all aspects, application hardware and software of the invention.

In an embodiment of the invention, the algorithms for all the new versions are outlined below.

### DESCRIPTION OF FIGURES. OVERVIEW OF NEW UMMDA ALGORITHMS

FIG. 1 All UMMDA hardware, software programs, and algorithms are managed by one algorithm-called the Matriarca Algorithm.

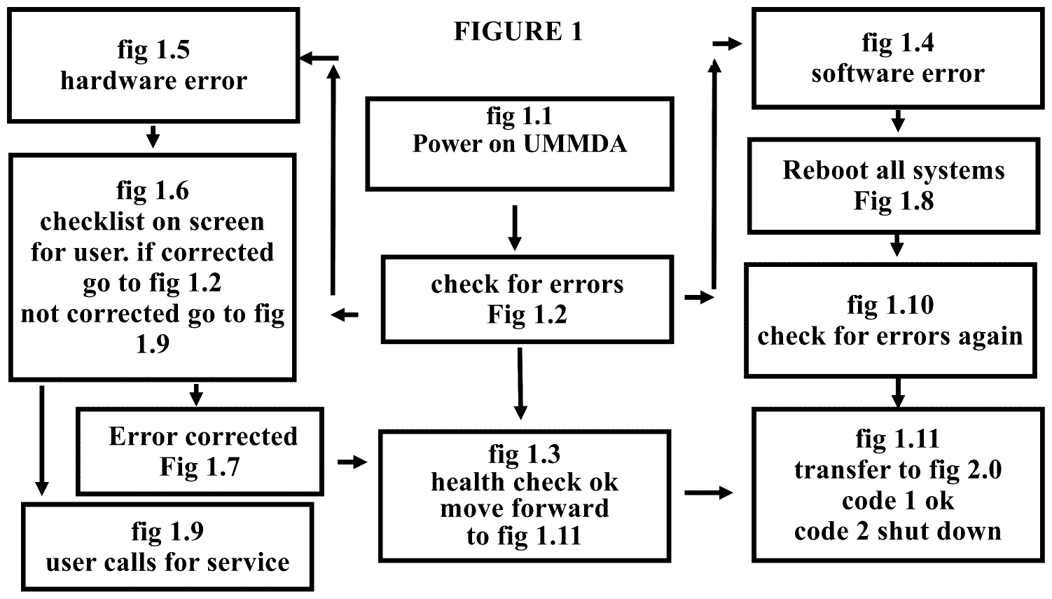

FIG. 2 Operational and Management software programs and algorithms-are called the Instruction Algorithms.

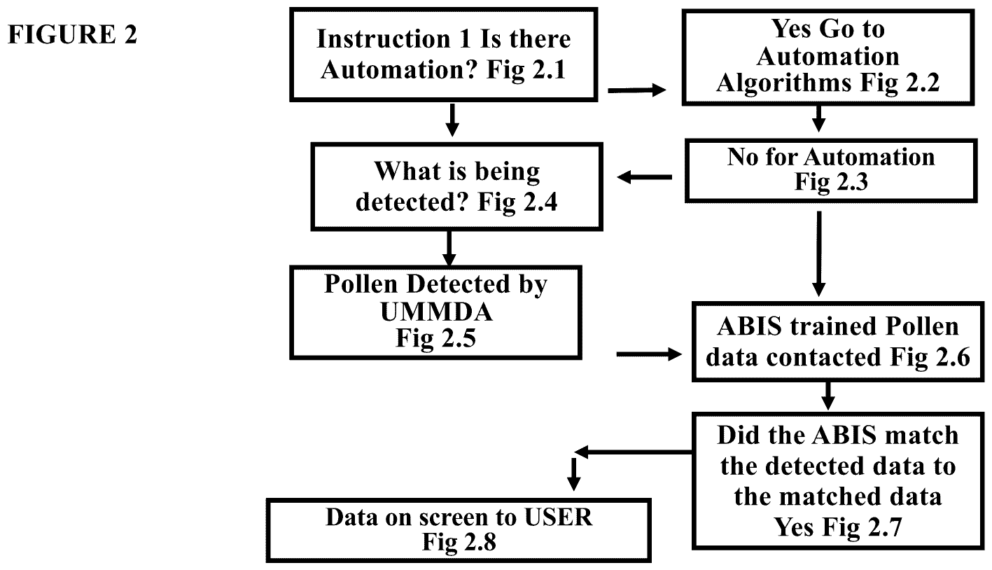

FIG. 3 Error Management Algorithms-are called Error Algorithms.

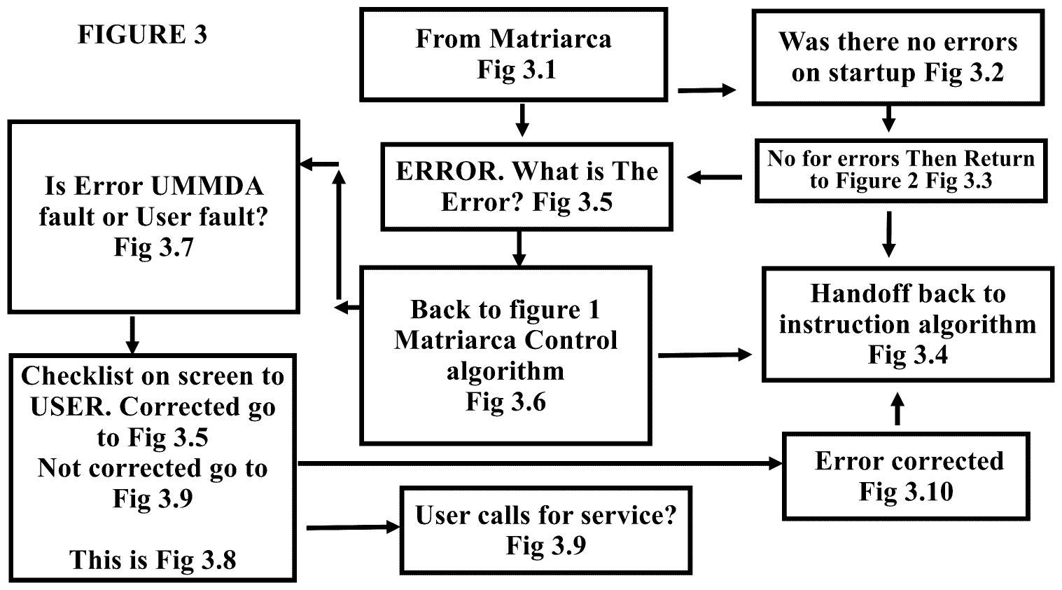

FIG. 4 Machine Learning Algorithms-are called the Machine Learning Algorithms.

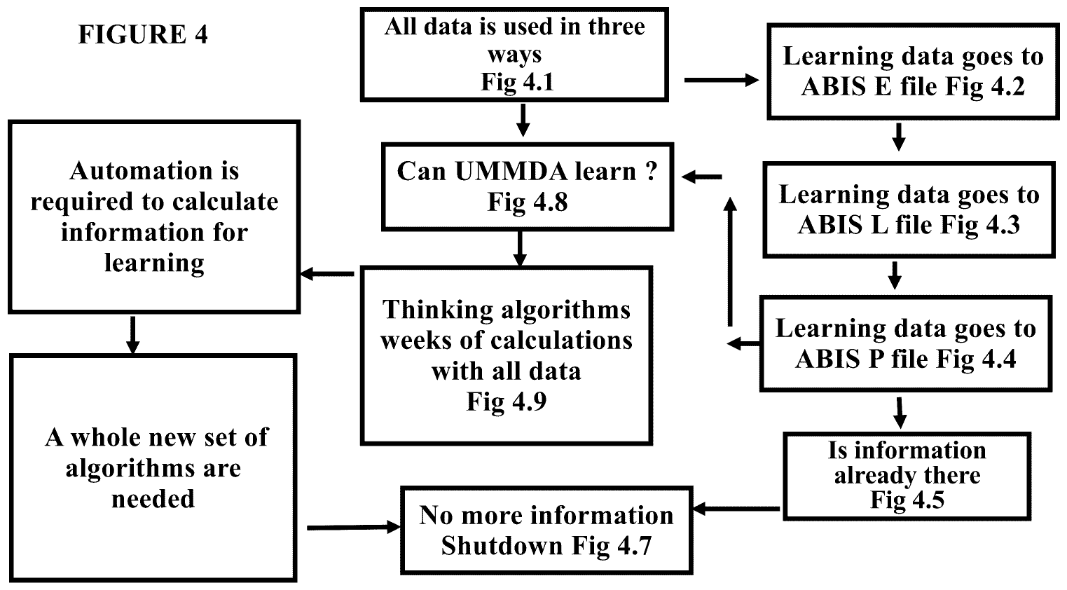

FIG. 5 Future Events Algorithms-are called the Predictive Algorithms.

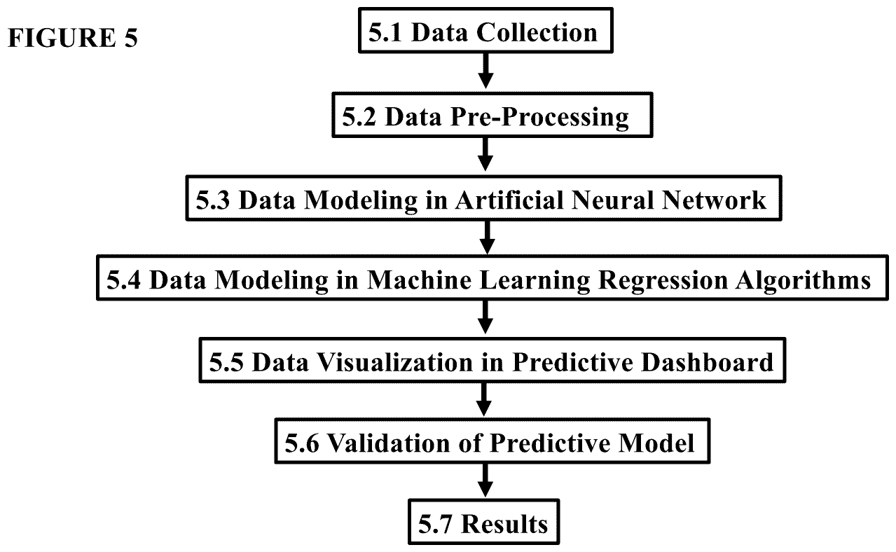

FIG. 6 Data Base Algorithms-are called ABIS Algorithms.

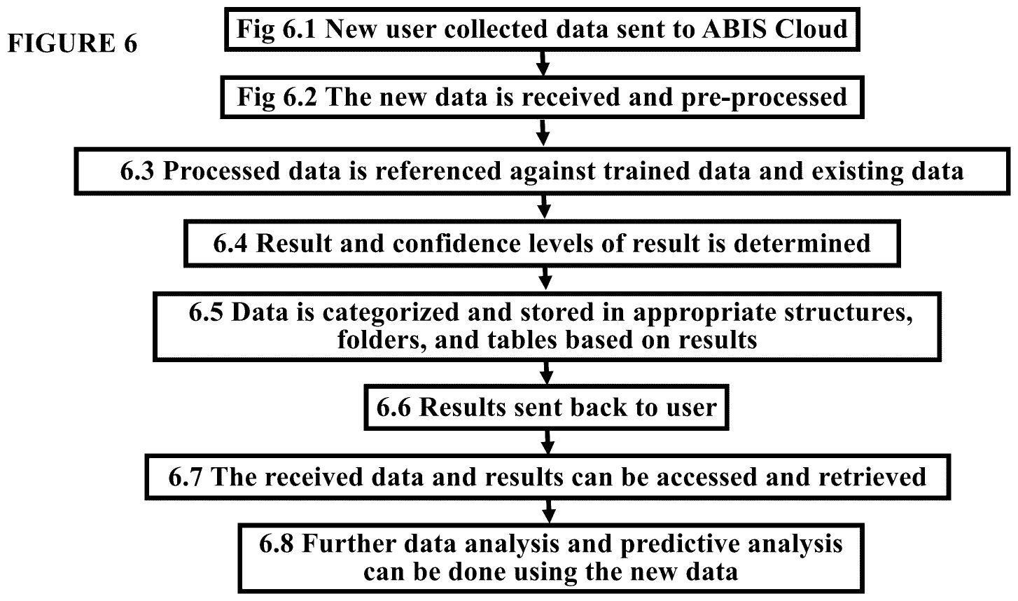

FIG. 7 Deposit Receptacle-water soluble screen for urine, sputum, and feces.

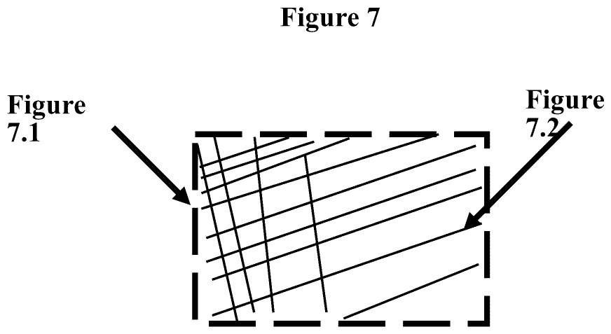

FIG. 8 Receptacle pin prick device for blood testing in humans and animals.

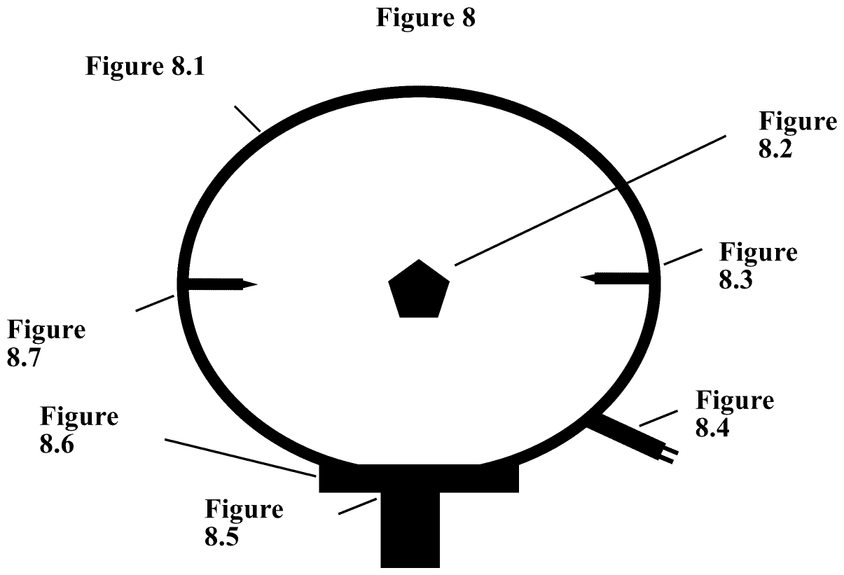

FIG. 9 UMMDA Hand grip schematics.

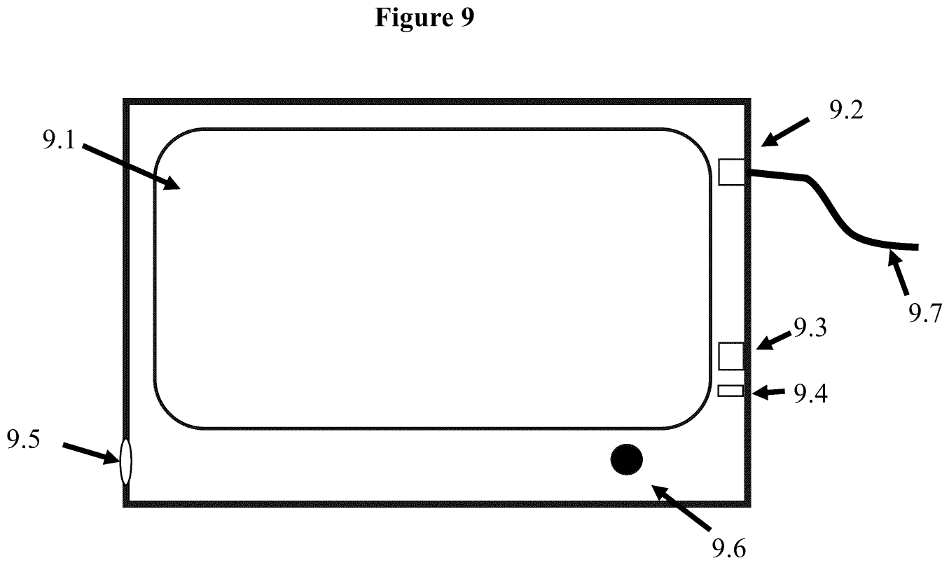

FIG. 10 Liquid tube cartridge and deposit receptacle.

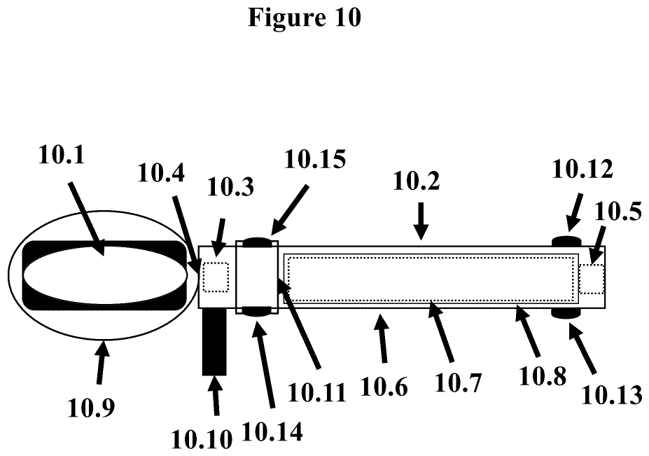

FIG. 11 Embedded microscope slides in liquid tube.

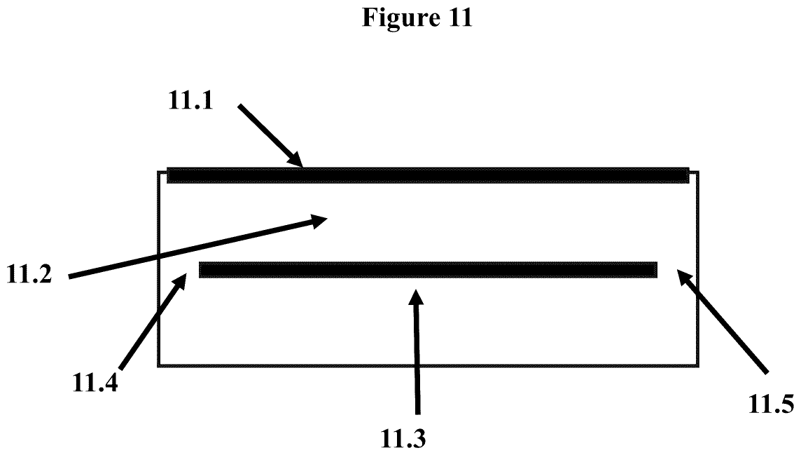

FIG. 12 Liquid tube cartridge with magnets side view.

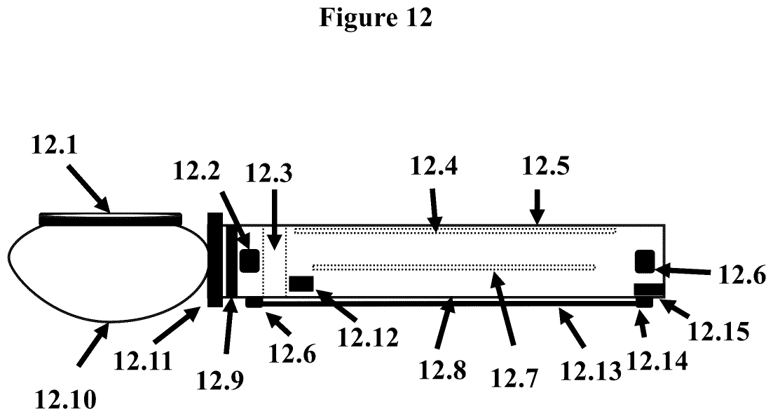

FIG. 13 UMMDA hand grip internal.

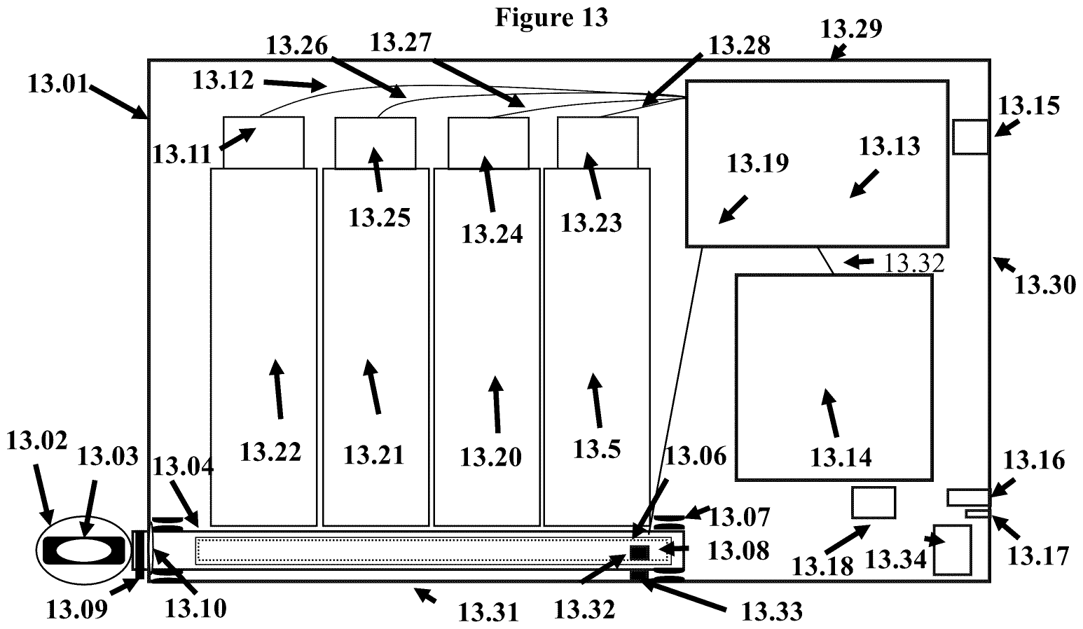

FIG. 14 Swivel Cover.

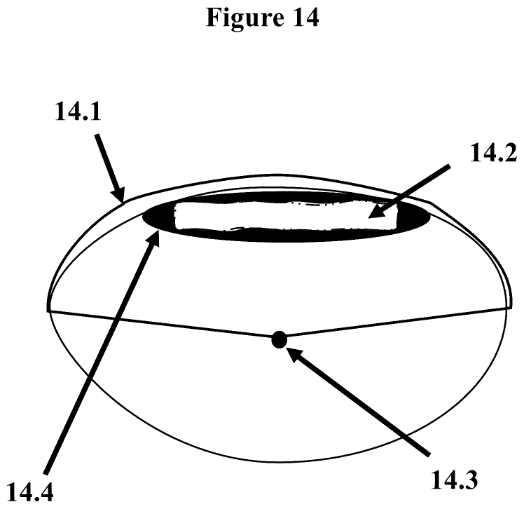

FIG. 15 Liquid tube cartridge and UMMDA hand grip version with magnets affixed

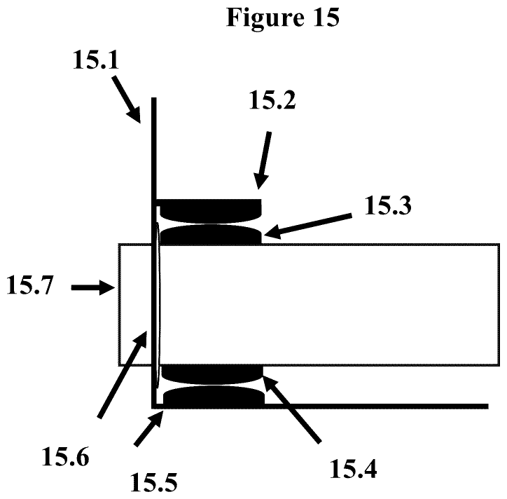

FIG. 16 Liquid tube cylinder slot top view

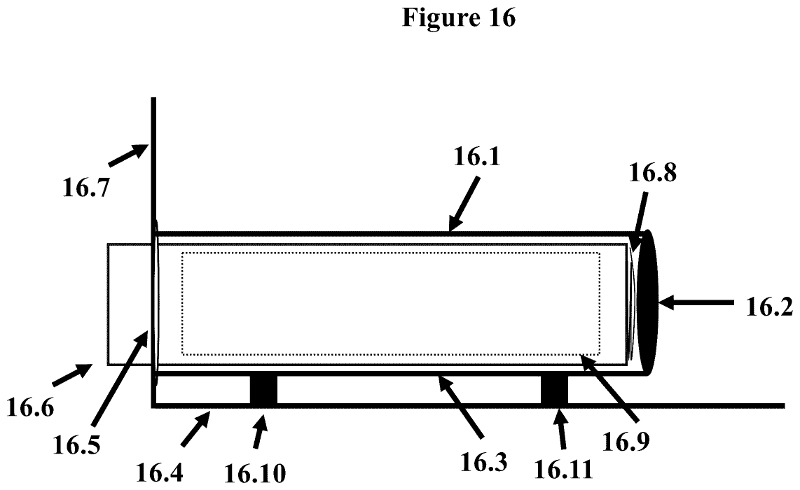

FIG. 17 Liquid tube cylinder slot side view.

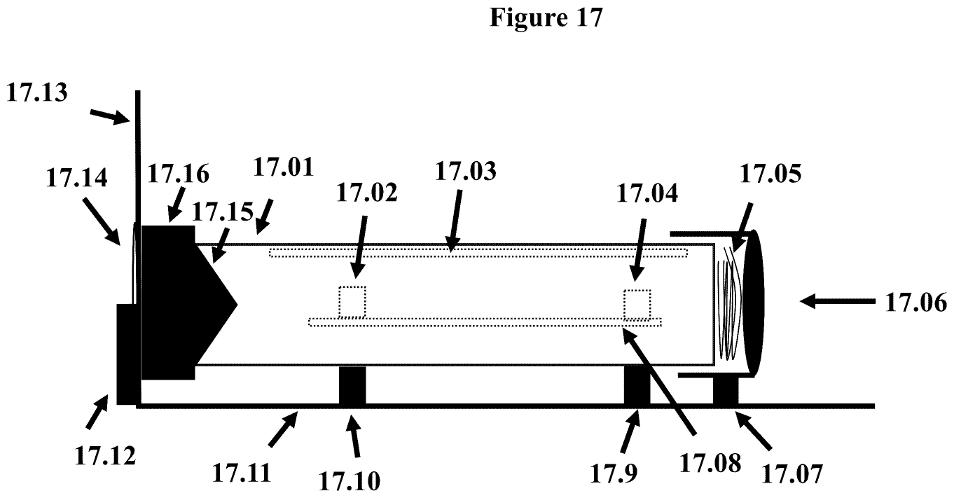

FIG. 18 Liquid tube cartridge valve

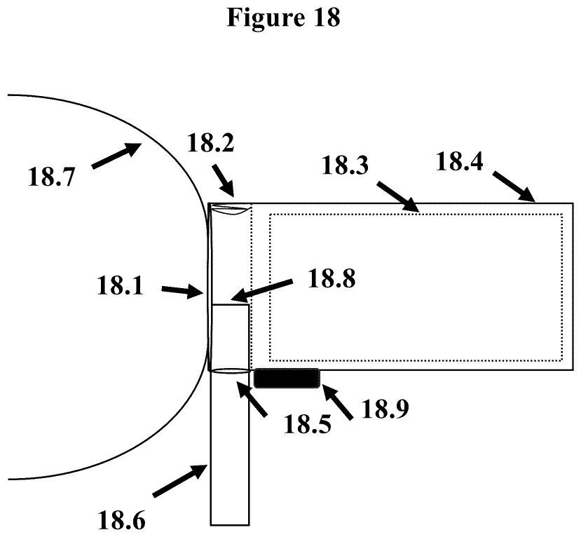

FIG. 19 Reservoir for depositing of matter

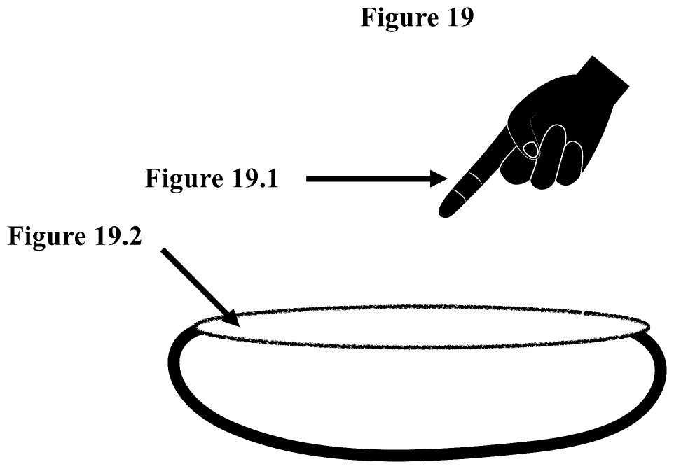

FIG. 20 Covering of the receptable with water soluble materials

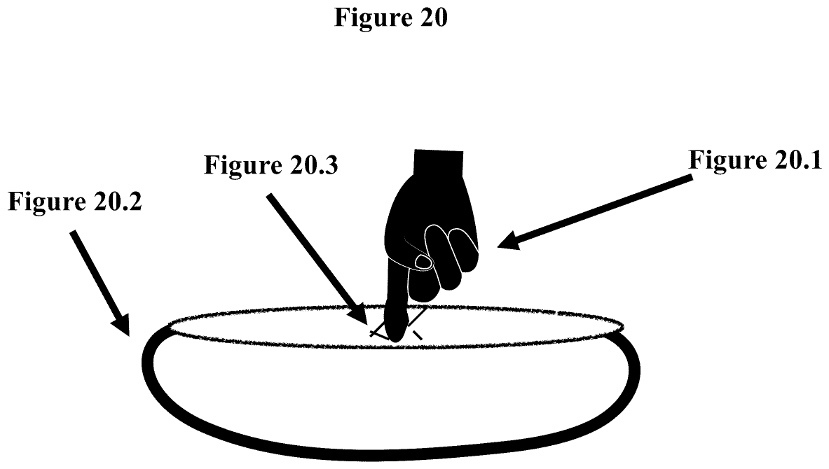

FIG. 21 Reservoir with pin prick for blood inducement

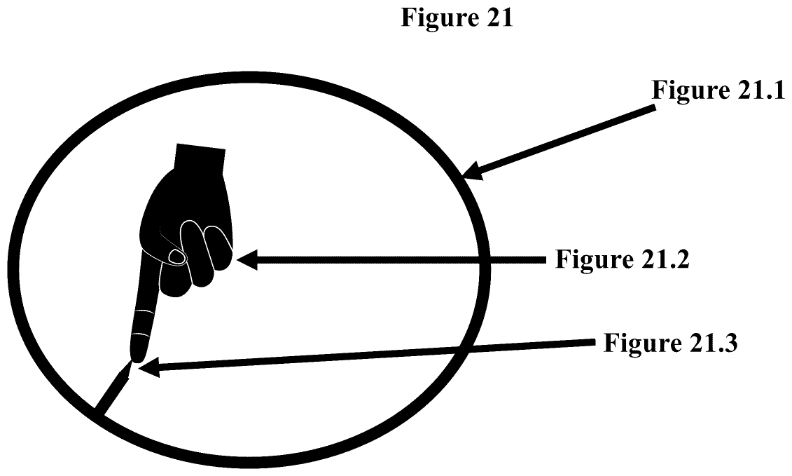

FIG. 22 Industrial UMMDA version

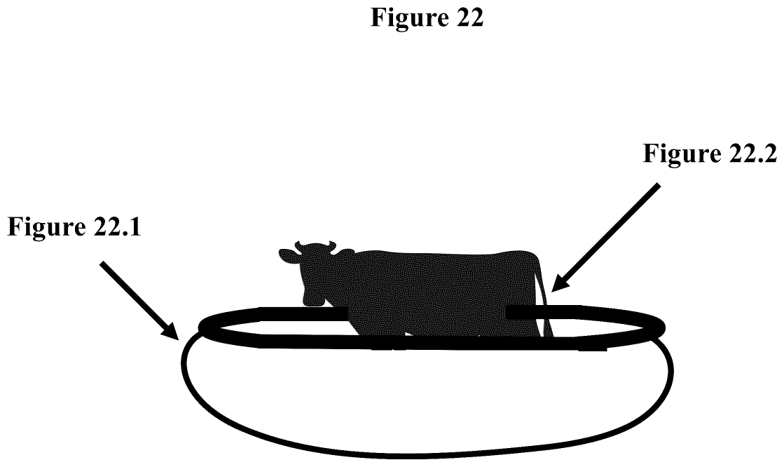

FIG. 23 Replaceable and reusable receptacle and liquid tube cartridge

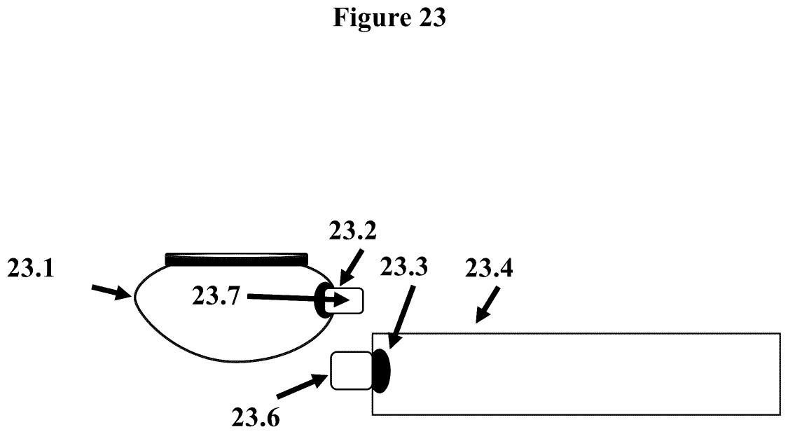

FIG. 24 Liquid tube cartridge with magnetic pump

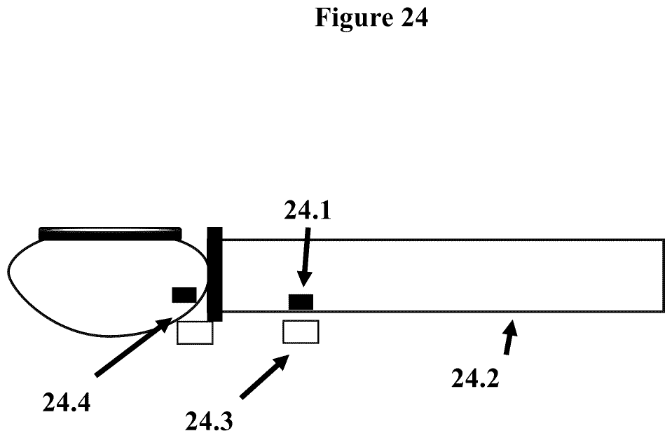

FIG. 25 Receptacle and liquid tube cartridge pump connected with a tube

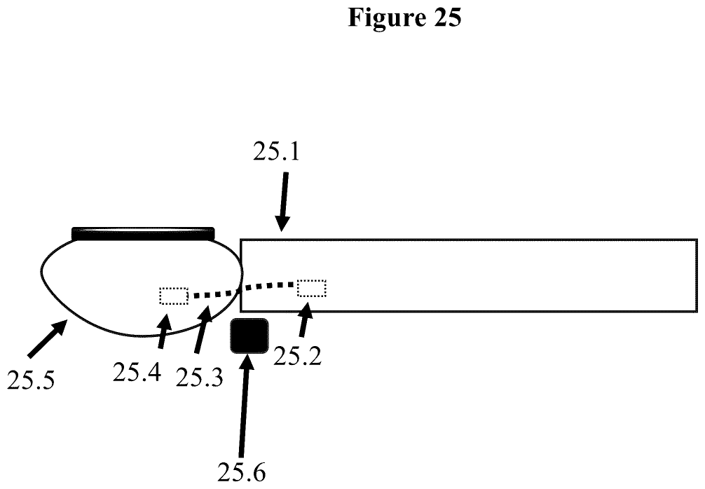

FIG. 26 Liquid tube cartridge and receptacle without magnets

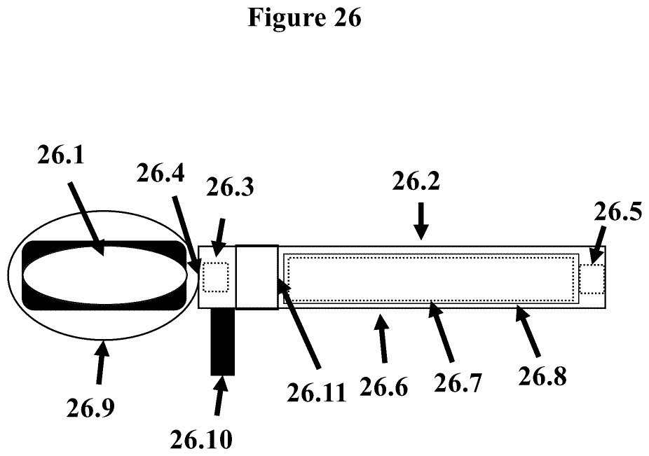

FIG. 27 Liquid tube cartridge without magnets side view.

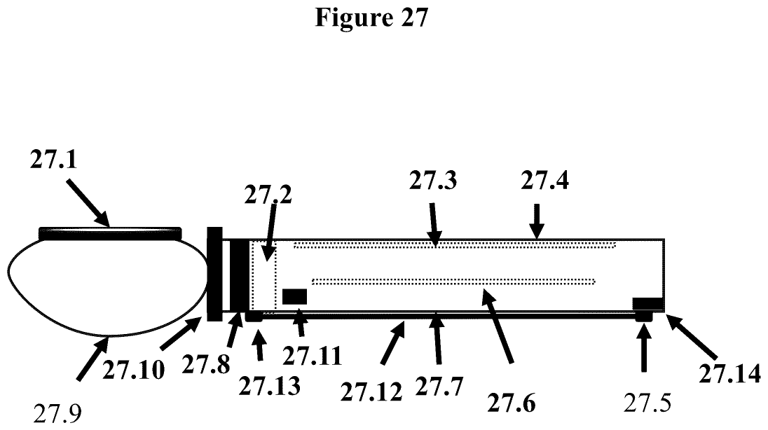

FIG. 28 Swivel latch

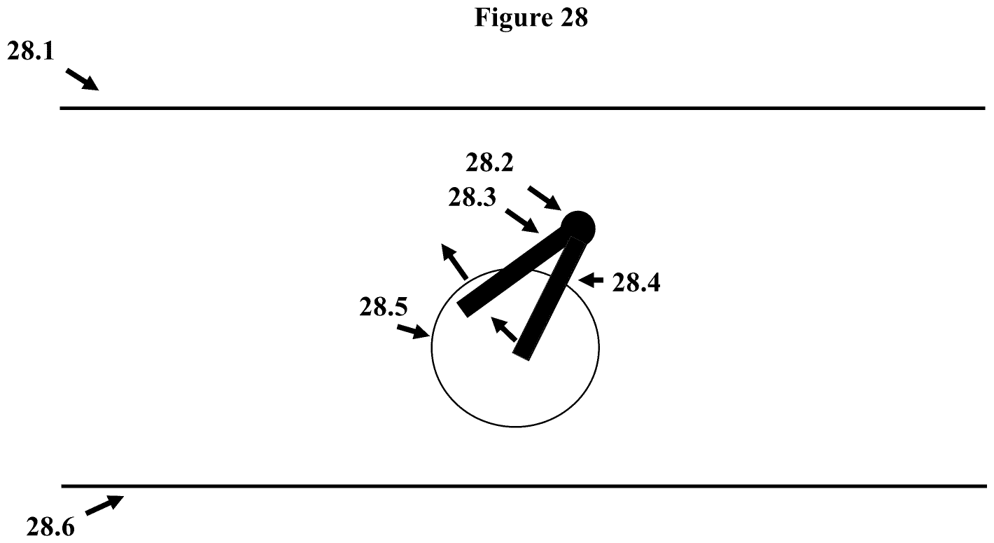

When used in this application, algorithm and algorithms are defined as a set of rules, step by step plans, and sequence of instructions that specify how to solve a problem or perform a calculation. The algorithms may run repeatedly until terminated. The term computer software program has the same characteristics as an algorithm but for purposes of this application, the following definition applies. Computer software program is defined as a computer software application that is easier to maintain than algorithms, easier to update, easier to fix bugs, and usually has an interface to allow for end users to interact with the software program. For purposes of this application, all computer software programs, and algorithmic software programs will be referred to as algorithms, the plural tense. Some of the third-party hardware such as drones, robots, pumps, string and or track lighting, and microscopes that are used with the UMMDA are purchased from third parties. The 3D printers mentioned are either bought, rented or companies that specialize in 3D printing are hired. The software is bundled with the hardware when purchased, leased, licensed, or is free to use, download form the internet or amend the software code. Some of the computer written code for the UMMDA is written strictly for the UMMDA, while other code is offered for free from third parties, still further some software code is licensed. All software code and algorithms utilized by the UMMDA may be used singularly or be used in any combination of all the software choices mentioned in this application. For purposes of this application, when a block on a flowchart is referenced, it usually means it's an algorithm that is referenced.

All databases, database applications, and database algorithmic technology of the UMMDA will be referred to Automated Biosensing Imaging System or “ABIS” technology as just ABIS.

For purposes of this application, the algorithmic overview in this section relates to the limited number of algorithms utilized on the low-end version of the UMMDA. All components whether they are hardware based or computer software program based will be referred to as the entire UMMDA application.

### Reference Characters for Figures Description of Figures and Flowcharts of New UMMDA Algorithms are located in a corresponding document titled “Reference Character”.

Definitions of the hand held apparatus may also include, hand held, manual hand held apparatus, hand held unit, hand held device, hand grip, hand grip apparatus, counter top unit, apparatus, device, liquid tube apparatus, UMMDA hand held or hand held apparatus.

Definitions of the replaceable liquid tube cartridge unit may be also include, liquid tube unit, disposable cartridge, cassette, replaceable cartridge, liquid tube unit, liquid tube cartridge with receptacle, deposit liquid tube receptacle, and replaceable cartridge or just cartridge.

The receptacle may be referred to as a single unit of the unit together with liquid tube unit. The liquid tube unit is located inside of the hand held apparatus while the receptacle is located outside the hand held.

1. A liquid tube replaceable cartridge unit is utilized in an enclosed hand held apparatus that detects matter and micro-organisms in real time using algorithms.

2. A claim according to claim 1 where the liquid tube replaceable cartridge unit can be removed from the hand held apparatus then replaced by rotating both swivel levers away from the center of the liquid tube replaceable cartridge unit top on the side of hand held apparatus and sliding out the liquid tube replaceable cartridge unit and replacing another unit in the same reversed manner.

3. A claim according to claim 1 whereby numerous water tight liquid tube replaceable cartridge units can consist of a plurality of different components that can be added or removed including a receptacle.

4. A claim according to claims 1, 2 and 3 whereby the hand held apparatus allows for medical professionals, robots, or both to perform testing of matter, then replace the liquid tube cartridge unit for another matter detection process and method.

5. A claim according to claims 1 through 3 where the replaceable cartridge unit is disposable, cleanable, or can be reconditioned to be reused.

6. A claim according to claim 4 whereby a 3D printer constructs the liquid tube replaceable cartridge unit with microscope slides embedded in the unit.

7. A claim according to claim 6 where the liquid tube replaceable cartridge unit is constructed with 2 elongated microscope slides with an opening at one end that maintains a ridge for a rubber cap to seal liquid inside the liquid tube replaceable cartridge unit.

8. A claim according to claim 1 where the replaceable cartridge unit is filled with a liquid during or after construction.

9. A claim according to claim 6 where the replaceable cartridge unit is constructed with a receptacle for depositing matter into the receptacle that can be pressed onto the end of replaceable cartridge unit, or the receptacle can be constructed together with the replaceable cartridge unit as one unit.

10. A claim according to claim 1 where a magnetic operated pump affixed to the inside the replaceable cartridge unit can be operated from outside the liquid tube cartridge by a separate control unit located inside the hand held apparatus.

11. A claim according to claim 1 where a magnetic pump can be powered and operated from the inside the receptacle, another separate pump can operate inside the liquid tube cartridge whereby they can be connected to each other by a hose or not connected and operated separately.

12. A claim according to claim 1 where a liquid tube replaceable cartridge is connected to a receptacle that can intake human bodily fluids and transfer that matter into the replaceable cartridge unit for testing.

13. A claim according to claim 1 where the hand held apparatus can be a mobile battery-operated unit for the accurate detection of matter and micro-organisms in real time using algorithms whereby the panel cover located on the back of hand held apparatus can be removed and the battery inside the hand held apparatus can be replaced or recharged wirelessly or by a plug connected to an electrical outlet.

14. A claim according to claim 1 where the liquid tube replaceable cartridge can be slide in and out of the hand held apparatus outside casing by swiveling a level to hold the replaceable cartridge unit in place in the hand held apparatus.

15. A claim according to claim 1 where the hand held apparatus back panel cover of the hand held unit can also be removed to replace the liquid tube replaceable cartridge unit.

16. A claim according to claim 1 where a receptacle can intake human bodily fluids and transfer that matter into the replaceable cartridge unit for testing.

17. A claim according to claim 1 whereby the replaceable cartridge unit can be filled with a liquid during construction and sealed or filled with a liquid after construction by a medical professional and sealed.

18. A claim according to claim 15 whereby matter deposited into a recepticle can be transferred into a connected replaceable cartridge unit connected to the hand held for testing.

19. A claim according to claim 18 whereby a medical professional can operate the hand held apparatus manually through a touch screen, remove the replaceable liquid tube cartridge or replace the liquid tube cartridge in the hand held apparatus.

20. A claim according to claim 18 whereby the hand held apparatus can be operated autonomously by a robot, a drone or both.
